(19) United States
(12) Patent Application Publication
(10) Pub. No.: US 2025/0365198 A1
(43) Pub. Date: Nov. 27, 2025

(54) Systems And Methods For Dynamic Provisioning Of Clusters Within A Cloud Environment

(71) Applicant: Oracle International Corporation, Redwood Shores, CA (US)

(72) Inventors: Sameer Suhas Deokule, Fremont, CA (US); Tharun Sikhinam, Seattle, WA (US); Md Kaiser Ahmed, Corinth, TX (US); Dmitry Polyakovsky, Seattle, WA (US)

(73) Assignee: Oracle International Corporation, Redwood Shores, CA (US)

(21) Appl. No.: 18/674,673

(22) Filed: May 24, 2024

(51) Int. Cl. H04L 41/0823

(52) U.S. Cl. CPC H04L 41/0836

(57) ABSTRACT

Techniques are described herein for dynamically provisioning clusters in cloud environments based on specific node configurations. Systems and methods involve receiving a request to set up a cluster with multiple nodes, each requiring a particular configuration. The process begins with assessing if it's feasible to provision all nodes as requested. If not, the method identifies which subset of nodes can be provisioned initially and proceeds accordingly. After the initial provisioning, a further assessment is made to determine which additional subset of nodes can be provisioned next. This approach enables the gradual setup of complex clusters in a flexible manner, adapting to available resources and configurations in real-time.

### TECHNICAL FIELD

The present disclosure relates to cloud computing. More specifically, it relates to systems and methods for dynamic provisioning of clusters within a cloud environment.

### BACKGROUND

Cloud computing has been widely adopted for scalable and on-demand resource management in modern applications. Clusters of nodes are pivotal in supporting distributed workloads, databases, and computing tasks within these environments, ensuring high availability and fault tolerance. The provisioning and management of clusters play a crucial role in ensuring optimal performance and resource utilization. Traditional approaches often require manual intervention and lack automation and efficient resource allocation, leading to inefficiencies in resource allocation and deployment.

As cloud environments evolve to accommodate diverse workloads and dynamic resource demands, there is a growing need for automated methods to provision clusters efficiently

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with some embodiments;

FIG. 2A illustrates an example set of operations for dynamic provisioning of clusters within a cloud environment, in accordance with some embodiments;

FIG. 2B illustrates an example set of further operations for dynamic provisioning of clusters within a cloud environment, in accordance with some embodiments;

FIG. 3 illustrates an example embodiment where provisioning nodes is performed in a distributed fashion across availability domains and fault domains, in accordance with some embodiments; and

FIG. 4 illustrates a computer system where some embodiments may be implemented.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. ARCHITECTURAL OVERVIEW
3. DYNAMIC PROVISIONING OF A CLUSTER WITHIN A CLOUD ENVIRONMENT
4. PROVISIONING NODES IN A DISTRIBUTED FASHION
5. HARDWARE OVERVIEW
6. MISCELLANEOUS; EXTENSIONS

### 1. General Overview

Techniques are presented herein for dynamically provisioning clusters in cloud environments based on specific node configurations. Embodiments include receiving a request to set up a cluster with multiple nodes. A provisioning process assesses whether it is feasible to provision all nodes as requested. If not, the process identifies which subset of nodes can be provisioned initially and proceeds accordingly. After the initial provisioning, a further assessment is made to determine which additional subset of nodes can be provisioned next. The process may thus provide a gradual setup of complex clusters in a flexible manner, adapting to available resources and configurations in real-time.

One or more embodiments described in this Specification and/or recited in the claims may not be included in this General Overview section.

### 2. Architectural Overview

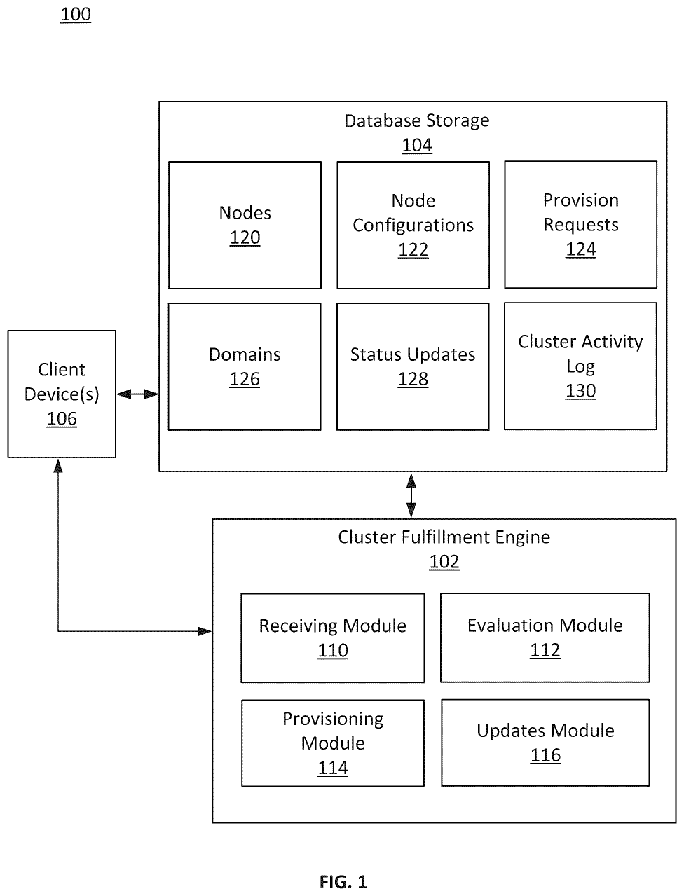

FIG. 1 illustrates an exemplary system 100 in accordance with some embodiments. As illustrated in FIG. 1, the system 100 includes cluster fulfillment engine 102, database storage 104, and client device(s) 106. In the system 100, one or more client device(s) 106 are connected to a cluster fulfillment engine 102 and a database storage 104. The cluster fulfillment engine 102 is connected to the database storage 104. The cluster fulfillment engine may also be connected to one or more repositories and/or databases, including, e.g., repositories for: nodes 120, node configurations 122, provision requests 124, domains 126, status updates 128, and a cluster activity log 130. Such data and/or data objects will be described in further detail below. One or more of the databases and/or data repositories may be combined or split into multiple databases and/or repositories. The client device(s) 106 in this environment may be one or more computers, and the cluster fulfillment engine 102 may be an application or software hosted on a computer or multiple computers that are communicatively coupled via remote server or locally.

In one or more embodiments, system 100 may include more or fewer components than the components illustrated in FIG. 1. The components illustrated in FIG. 1 may be local to or remote from each other. The components of cluster fulfillment engine 102, database storage 104, and/or client device(s) 106 may be distributed over multiple applications and/or machines. Multiple components may be combined into one application and/or machine. Operations described with respect to one component may instead be performed by another component.

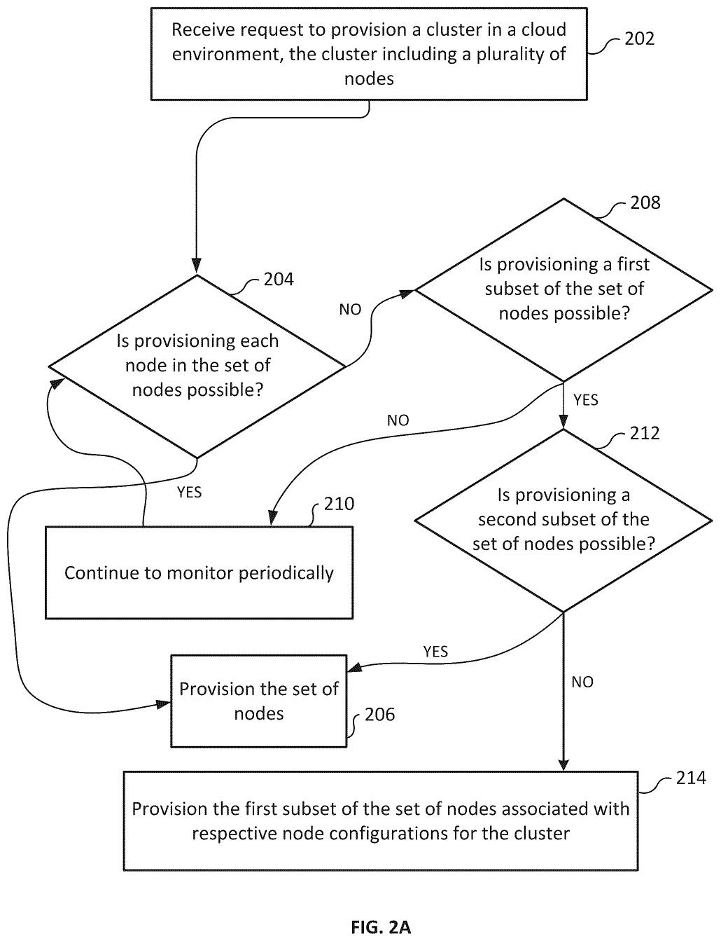

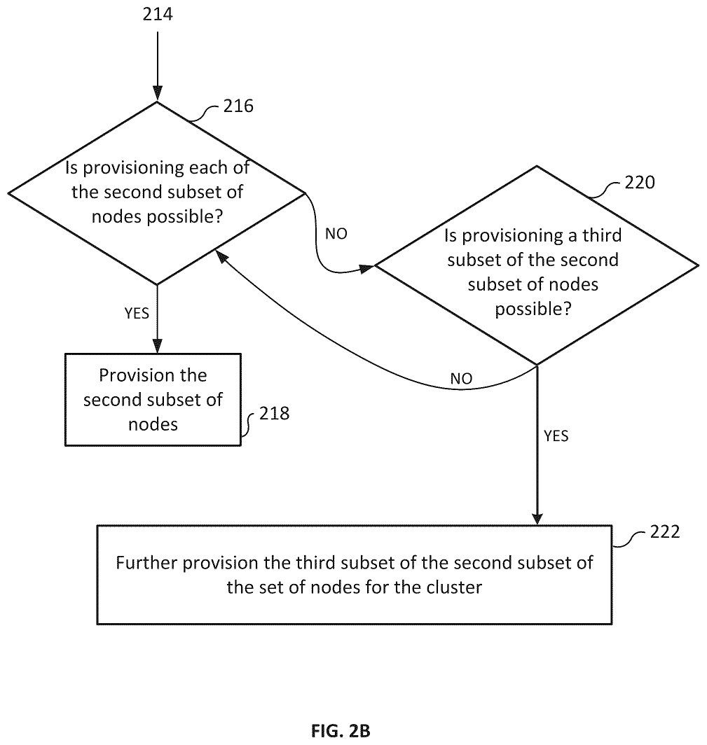

In one or more embodiments, cluster fulfillment engine 102 may perform the method of FIG. 2 or other method herein and, as a result, dynamically provision a cluster in a cloud environment. In one or more embodiments, the provisioning process may be accomplished via communication with the client device(s) 106, database storage 104, and/or other device(s) over a network between the device(s) and an application server or some other network server. In one or more embodiments, the cluster fulfillment engine 102 is an application, browser extension, or other piece of software hosted on a computer or similar device, or is itself a computer or similar device configured to host an application, browser extension, or other piece of software to perform some of the methods and embodiments herein.

In one or more embodiments, client device(s) 106 are one or more computing devices that are connected to a computer network. A computing device generally refers to any hardware device that includes a processor. A computing device may refer to a physical device executing an application or a virtual machine. Examples of computing devices include, e.g., a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, each of the client device(s) are associated with a respective set of computing resources. Computing resources may comprise, e.g., software and/or hardware resources used in the execution of one or more applications by the associated host. Example computing resources may include, e.g., central processing units (“CPUs”), network ports, database connections, user sessions, memory, operating systems, application instances, and virtual machine instances. Additionally, or alternatively, a host may include other computing resources, which may vary from one host to the next. In one or more embodiments, the cluster fulfillment engine 102 may be hosted in whole or in part as an application or web service executed on the client device(s) 106. In one or more embodiments, one or more of the database storage 104, cluster fulfillment engine 102, and client device(s) 106 may be the same device.

In various embodiments, the database storage 104 store and/or maintain information for the cluster fulfillment engine 102 to perform elements of the methods and systems herein. In one or more embodiments, the database storage 104 may be queried by one or more components of system 100 (e.g., by the cluster fulfillment engine 102). In response, specific stored data satisfying the query criteria may be retrieved from the database(s).

In one or more embodiments, one or more components of system 100, including cluster fulfillment engine 102, may be implemented as or integrated into a cloud service, such as a software-as-a-service (“SaaS”) or a platform-as-a-service (“PaaS”).

Receiving module 110 functions to receive requests for provisioning a cluster in a cloud environment.

Evaluation module 112 functions to perform evaluations, including, e.g., whether provisioning each node of a set of nodes is possible, and whether provisioning each of a subset of a set of nodes is possible.

Provisioning module 114 functions to provision nodes for a cluster in a cloud environment.

Updates module 116 functions to send one or more updates, such as real-time status updates, regarding the status of provisioning the cluster within the cloud environment.

These modules and their functions will be described in further detail below with respect to FIG. 2.

### 3. Dynamic Provisioning of a Cluster within a Cloud Environment

### 3.1 Initial Feasibility Analysis and Node Provisioning

FIG. 2A illustrates an example set of operations for dynamically provisioning a cluster in a cloud environment, in accordance with some embodiments. One or more operations illustrated in FIG. 2A may be modified, rearranged, or omitted altogether. Accordingly, the particular sequence of operations illustrated in FIG. 2A should not be construed as limiting the scope of one or more embodiments.

In an embodiment, the system receives a request from a user or an automated system to provision a cluster in a cloud environment (Operation 202). As previously noted, a cluster includes a set of nodes where each node in the set of nodes is associated with a respective node configuration and corresponds to one or more cloud computing resources. For example, a cluster may include a group of interconnected computers or servers within a cloud environment that work together to perform tasks as a single system. Clusters may be used to enhance performance, reliability, and scalability of applications and services by distributing workloads across multiple “nodes”. Other examples of nodes include physical machines or virtual instances running on a cloud platform. Within this context, “provisioning” a cluster includes setting up and configuring cloud resources and components to establish and operate the cluster. Provisioning operations may include (a) allocating computing resources such as virtual machines, containers, or physical servers, (b) configuring networking settings, (c) installing required software and applications, and (d) integrating the nodes into a unified system capable of performing the intended tasks.

For example, a web application may experiences varying levels of traffic throughout the day. To ensure consistent performance and availability, the application may be deployed on a cluster of virtual machines managed by a cloud provider. The cluster may consist of multiple instances of web servers, application servers, and database servers interconnected to handle incoming requests efficiently. Provisioning this cluster may include, for example, specifying the number of each type of server to use, setting up networking rules to allow communication between components, installing supporting software (such as, for instance, Apache HTTP Server, Tomcat, and MySQL), and configuring load balancers to distribute incoming traffic.

In another scenario, a data processing pipeline may analyze large volumes of data in real-time. The pipeline may be implemented using a cluster of computing nodes equipped with specialized hardware or software for data processing tasks such as data ingestion, transformation, and analysis. Provisioning a cluster in this scenario may include allocating instances with sufficient CPU, memory, and storage resources, installing data processing frameworks like, e.g., Apache Spark or Hadoop, and configuring the nodes to work together seamlessly to process incoming data streams efficiently.

In one or more embodiments the request to provision the cluster specifies the desired cluster configuration. The specified cluster configuration may include details such as, for example, the number of nodes required, the type of nodes (e.g., virtual machines or containers), and specific configurations for each node (e.g., CPU, memory, storage). The request may be submitted via an application programming interface (API), a web-based portal, or through command-line tools interfacing with the cloud environment. For instance, a user may submit a request specifying the desired cluster size and node configurations through a web-based console provided by a cloud service provider.

Once the request is received, one or more embodiments may validate the request parameters to ensure they conform to predefined policies and constraints. These policies may represent established, prespecified rules that govern various aspects of provisioning operations. For example, a policy might restrict the allocation of certain node types or configurations based on the user's subscription tier or organizational policies. As another example, the policies may enforce resource allocation limits and security constraints.

In one or more embodiments, they system assesses the request parameters against predefined policies to verify that the requested resources align with the allowed configurations and limits. For example, if a user is operating under a certain subscription level that limits access to high-performance node types, the system may validate the request to ensure that only permitted node types are provisioned. Additionally, security requirements such as, e.g., network isolation policies or encryption standards may influence the validation process. If the request specifies certain security settings, such as data encryption or compliance with specific regulatory standards, the system will validate the parameters to confirm adherence to these security policies.

One or more embodiments receive a request which specifies a cluster configuration that includes specific parameters for the provisioning process. Example configuration parameters may specify a number of shards to provision, a number of nodes to provision, and/or an amount of memory to allocate for the nodes. For instance, the request may identify how many shards a customer would like to provision. In this context, shards represent partitions of data distributed across nodes within the cluster, enabling parallel processing and scalability. The request may include the desired number of shards to optimize data storage and retrieval performance. Additionally or alternatively, the request may specify the number of nodes to provision for the cluster. The number of nodes directly impacts the cluster's computing power, fault tolerance, and data redundancy. One or more embodiments may parse this parameter to determine the scale of resources needed for node provisioning. Furthermore, the cluster configuration may include a specified memory allocation for each node. This allocation determines the amount of memory available to individual nodes within the cluster, influencing their ability to handle data processing tasks and storage requirements efficiently. The target configuration parameters may or may not be available at the time of the request depending on various factors including the current infrastructure of the cloud environment, what resources have been provisioned for the current and/or other customers, and the current demands on the cloud resources.

In one or more embodiments, the request includes performance-based configuration parameters to guide the provisioning process. Performance-based configuration parameters may specify performance targets for nodes and clusters to guide provisioning operations. Example performance targets may include target memory allocation and/or utilization for each node, a target number of shards to be included in each node, and a target number of nodes/resources to be provisioned for the cluster. For example, one or more embodiments allow administrators to specify the memory allocation for each node based on application requirements and performance objectives. By configuring memory allocation, operators can optimize resource utilization and enhance application performance within the cluster. Such flexibility may provide efficient management of node resources while accommodating varying workload demands.

Additionally or alternatively, requests may define the desired number of shards within the cluster, which influences data partitioning and distribution across nodes. In the context of performance-based parameters, the request may indicate that a shard configuration is targeted to align with data processing targets, such as target CPU utilization caps and/or other captured processing metrics, which provides effective data distribution and parallel processing capabilities within the cluster. If the processing targets are not met (e.g., the CPU utilization cap is exceeded or within a threshold close to being exceeded), then the system may modify the shard configurations on one or more nodes. By adjusting shard count dynamically, the system may optimize data access and query performance.

Additionally or alternatively, a target number of nodes to be provisioned for the cluster may be determined based on the performance-based parameters. For example, the performance-based parameters may be based on various factors such as resource availability and workload requirements. Operators may specify the target node count based on anticipated workload fluctuations and scalability needs. Such dynamic provisioning of nodes may help provide efficient resource utilization and enables rapid scalability in response to changing demand.

In one or more embodiments, the system performs a first evaluation of whether provisioning each node of the set of nodes is possible (Operation 204). If the system determines as the result of this evaluation that provisioning each node of the set of the nodes is possible, then the system proceeds to provision the set of nodes (Operation 206). Otherwise the system proceeds to evaluate whether provisioning a first subset of the set of nodes is possible (Operation 208).

Initially, upon receiving the request to provision a cluster, one or more embodiments assess the available resources and current capacity within the cloud environment to determine whether provisioning each node in the set of nodes is possible. The evaluation operation(s) may involve, for example, querying resource management systems to ascertain the availability of required node types, computing power, storage, and network bandwidth computed or estimated to be necessary to instantiate each node as specified in the node configuration. One or more embodiments may conduct an analysis of the requested node configurations against predefined resource allocation policies and constraints. For example, certain node types or configurations may be restricted based on subscription tiers, budget constraints, or organizational rules. The system may compare the requested node specifications against these policies to determine if they can be fulfilled without violating any constraints.

In one or more embodiments, the evaluation process performs predictive modeling or forecasting to anticipate resource demands and availability over a requested provisioning period. Modelling may include, for example, analyzing historical usage patterns, workload forecasts, and resource utilization trends to predict future resource availability accurately. A machine learning engine may train one or more models to extrapolate based on learned patterns from the analyzed data. A machine learning algorithm may apply one or more learning processes, such as backpropagation and/or regression, to train a machine learning model. The learning process may iteratively adjust model parameters to optimize an error function based on residuals between a pattern predicted by the model and an observed pattern in the captured workload data. Example machine learning models include neural networks, logistic regression models, support vector machines, decision trees, and generative language models. By leveraging machine learning algorithms and statistical methods, the system can estimate the likelihood of successfully provisioning each node within a target timeframe.

Additionally or alternatively to resource demands and availability, the evaluation process may analyze other factors such as, e.g., network connectivity, fault tolerance requirements, and data locality preferences. For instance, certain node configurations may require specific network configurations or placement within fault domains for redundancy and high availability. The system can evaluate one or more of these factors to ensure that the provisioning of each node aligns with the target cluster characteristics and operational parameters satisfying the request. For example, a request might specify the provisioning of a cluster with a specific number of compute-intensive nodes. The system may evaluate whether the cloud environment has sufficient available compute resources to accommodate these nodes based on current usage and constraints. If the target number of compute resources are available and compliant with policy constraints, the evaluation process may conclude that provisioning each node is feasible within the defined parameters.

If provisioning the full set of nodes is not possible, then the system determines whether provisioning a first subset of the set of nodes associated with respective node configurations is possible (Operation 208), and whether provisioning a second subset of the set of nodes associated with respective node configurations is possible (Operation 212). If the system determines that provisioning the first subset of the set of nodes is not possible, then the system continues to monitor periodically (Operation 210) to evaluate again whether provisioning each node in the set of nodes is possible (returning to Operation 204). On the other hand, if the system determines that provisioning the first subset of the set of nodes is possible, then the system proceeds to determine whether provisioning a second subset of the set of nodes associated with respective node configurations is possible (Operation 212). If yes, then the system provisions the full set of nodes (Operation 206), while if not, then the system proceeds to provision the first subset of the set of nodes associated with respective node configurations for the cluster (Operation 214).

One or more embodiments analyze the results of the first evaluation to categorize nodes into two subsets: those that can be provisioned, and those that cannot. The system may take into account the resource requirements and constraints associated with each node configuration. For example, if a certain node type or configuration exceeds available resources or violates policy constraints, the evaluation process may categorize the requested resource configuration as not feasible for provisioning. To facilitate this determination, one or more embodiments may employ decision-making algorithms or rule-based systems that evaluate each node's specifications against resource availability thresholds and policy constraints. Machine learning techniques may dynamically adjust these thresholds based on real-time resource usage patterns and historical data. For instance, if historical data indicates periodic resource shortages during specific timeframes, one or more embodiments may adjust feasibility thresholds accordingly.

In one or more embodiments, the system prioritizes the provisioning of critical or high-priority nodes within the feasible subset based on predefined rules or user-defined preferences. For example, prioritization may be based on node types and/or functions as specified in a cluster request. If a cluster request targets a mix of compute-intensive and storage-intensive nodes, the compute-intensive nodes may be given priority for inclusion in the first subset of nodes. Based on resource availability and policy constraints, the system may determine that provisioning the compute-intensive nodes is feasible (Operation 208), while provisioning the storage-intensive nodes is not (Operation 212) due to resource limitations. Nodes for critical workloads or applications may thus be prioritized over less critical ones to optimize resource allocation and meet operational requirements.

In one or more embodiments, the system provisions the first subset from the set of nodes (Operation 214). The provisioning process may interface with the cloud infrastructure's orchestration tools or APIs to allocate virtual instances corresponding to the specified node configurations. For example, if the cluster requires compute nodes with specific CPU and memory specifications, the process may interact with the cloud provider's provisioning services to instantiate virtual machines with the desired attributes. One or more embodiments may utilize infrastructure-as-code (IaC) tools such as, e.g., Terraform or AWS CloudFormation to define and deploy the necessary resources programmatically. This approach enables efficient and reproducible provisioning of nodes while adhering to predefined configuration templates and policies.

Additionally or alternatively, one or more embodiments implement fault-tolerant provisioning strategies to enhance the robustness of the deployment process. For instance, one or more embodiments may leverage deployment automation tools such as, e.g., Kubernetes or Docker Swarm to distribute the provisioned nodes across multiple availability zones or fault domains, thereby minimizing the impact of potential infrastructure failures. Furthermore, one or more embodiments may incorporate real-time monitoring and feedback mechanisms to track the progress of node provisioning and handle any unforeseen issues or errors during deployment. For example, if a provisioned node fails to initialize properly, one or more embodiments can automatically trigger remedial actions, such as restarting the deployment process or rolling back to a previous state. For example, a cluster request may target provisioning of database nodes with specific storage and networking configurations. Using IaC scripts, the provisioning process may interact with the cloud provider's APIs to instantiate database instances with the target attributes, providing consistency and scalability across the cluster.

One or more embodiments deploy a number of instances, wherein the first subset of the set of nodes are provisioned on the number of instances. These instances serve as the underlying infrastructure on which the provisioned nodes will operate. One or more embodiments utilize virtualized instances provided by the cloud computing platform. For instance, one or more embodiments may interact with the cloud provider's APIs to initiate the creation of virtual machines (VMs) or container instances, each designed to host one or more nodes of the cluster. Alternatively, one or more embodiments may leverage container orchestration platforms like Kubernetes to manage the deployment of containerized nodes across a cluster of physical or virtual machines. This approach enables efficient resource utilization and scalability, aligning with the provisioning requirements defined in the cluster configuration. Furthermore, to optimize performance and fault tolerance, one or more embodiments may distribute the deployment of nodes across multiple instances spanning different availability domains and fault domains within the cloud environment. This distributed deployment strategy enhances resilience by mitigating the impact of potential instance failures or infrastructure issues within a single domain. Additionally, one or more embodiments may incorporate load balancing techniques during instance deployment to ensure equitable resource utilization across provisioned nodes. For example, instances hosting critical nodes or primary replicas may be evenly distributed across available instances to prevent resource bottlenecks and optimize performance.

### 3.2 Runtime Assessments for Dynamic Provisioning

Turning to FIG. 2B, the figure illustrates a continued method of dynamically provisioning a cluster in a cloud environment. FIG. 2B proceeds from FIG. 2A, where Operation 214 from FIG. 2A flows to Operation 216 of FIG. 2B, described below.

In an embodiment, the system performs a second evaluation of whether provisioning each of the second subset of the set of nodes associated with respective node configurations is possible (Operation 216). If yes, the system provisions the second subset of nodes (Operation 218), in a similar fashion to the system provisioning the first subset of nodes in Operation 214. If no, then the system proceeds to determine whether provisioning a third subset of the second subset of nodes is possible (Operation 220).

One or more embodiments undertake this evaluation by considering various factors such as, e.g., available cloud resources, subscription limits, and compliance with organizational policies. For example, one or more embodiments may assess the current resource utilization within the cloud environment to determine if sufficient capacity exists to accommodate the additional nodes specified in the second subset. To facilitate this evaluation, one or more embodiments may interact with cloud provider APIs to query resource availability and constraints in real-time. For example, one or more embodiments may retrieve information on available instance types, storage options, and networking configurations to inform the decision-making process. Furthermore, one or more embodiments may employ predictive analytics or machine learning algorithms to forecast future resource demands and identify potential bottlenecks in node provisioning. For instance, one or more embodiments may analyze historical usage patterns and workload trends to anticipate resource requirements and optimize node provisioning accordingly. In some embodiments, advanced scheduling algorithms are utilized to optimize resource allocation and minimize provisioning delays. For example, one or more embodiments may prioritize the provisioning of critical nodes based on workload dependencies or latency requirements to ensure timely cluster deployment. For example, consider a scenario where a cluster deployment request specifies the provisioning of additional compute nodes with specific performance characteristics. Using predictive analytics, one or more embodiments forecast the anticipated resource demands and assess whether the cloud environment can accommodate the specified node configurations within predefined constraints.

In an embodiment, based on the second evaluation, the system determines whether provisioning a third subset of the second subset of the plurality of nodes associated with respective node configurations is possible (Operation 220). If no, then the system returns to evaluating whether provisioning each of the second subset of nodes is possible (returning to Operation 216). If yes, the system proceeds to further provision the third subset of the second subset of the set of nodes for the cluster (Operation 222).

This determination involves a detailed assessment of resource availability, workload constraints, and compliance with specified node configurations. One or more embodiments conduct this determination by leveraging real-time data analytics and cloud monitoring tools to assess the current state of available resources. For instance, one or more embodiments may analyze the utilization of compute, storage, and networking resources to identify potential capacity constraints that could impact node provisioning. To facilitate this determination, one or more embodiments may utilize predictive modeling techniques to forecast resource demands and optimize provisioning strategies. For example, one or more embodiments may predict future workload patterns and adjust node provisioning plans accordingly to ensure optimal resource utilization. One or more embodiments employ advanced scheduling algorithms to prioritize the provisioning of critical nodes and optimize resource allocation. For example, one or more embodiments may dynamically adjust provisioning schedules based on workload dependencies or performance requirements to meet specified node configurations. One or more embodiments may interact with cloud provider APIs to query resource availability and constraints in real-time. For instance, one or more embodiments may retrieve information on available instance types, storage options, and networking configurations to inform the decision-making process. For example, consider a scenario where a cluster deployment request requires additional storage nodes with specific performance characteristics. Using predictive analytics, one or more embodiments forecast the resource requirements and assess whether the cloud environment can accommodate the specified node configurations within predefined constraints.

In one or more embodiments, the system further provisions the third subset of the second subset of the set of nodes associated with respective node configurations for the cluster (Operation 222). One or more embodiments initiate the provisioning process by interacting with the cloud infrastructure through APIs to allocate the necessary resources for the new nodes. For example, one or more embodiments may request the creation of virtual machine instances or containerized environments to accommodate the specified node configurations, such as CPU, memory, storage, and networking settings. Upon successful allocation of resources, one or more embodiments proceed to install and configure the software stack required for the newly provisioned nodes. This includes deploying applications, setting up data storage systems, and establishing network connections to integrate the new nodes into the existing cluster topology. To ensure scalability and fault tolerance, one or more embodiments may implement automated scaling policies to dynamically adjust the number of nodes based on workload demands. For instance, one or more embodiments may monitor system metrics such as CPU utilization, memory usage, and network traffic to trigger automatic scaling events when resource thresholds are exceeded. Additionally, one or more embodiments may perform health checks and validation procedures to verify the operational status and integrity of the newly provisioned nodes. For example, one or more embodiments may conduct connectivity tests, data replication checks, or performance benchmarks to ensure that the nodes meet the desired operational standards. In certain embodiments, advanced deployment orchestration tools and configuration management systems are utilized to streamline the provisioning process and enforce consistent configurations across the cluster. For example, one or more embodiments may employ tools such as, e.g., Kubernetes, Chef, or Ansible to automate node provisioning tasks and maintain IaC principles.

One or more embodiments provision the first subset of the set of nodes, as well as the third subset of the second subset of the set of nodes, in a distributed fashion across availability domains and fault domains. Availability domains are physically separate data centers within the same region that are isolated from each other in terms of power, cooling, and networking. These domains are designed to provide redundancy and high availability by ensuring that failures or disruptions in one availability domain do not affect others. Cloud services deployed across multiple availability domains can withstand failures or outages affecting a single domain, thereby enhancing reliability and uptime. Fault domains are logical or physical groupings of hardware resources (such as servers, network devices, or storage components) that share a common set of failure characteristics. Resources within the same fault domain are susceptible to the same failure events, such as power supply failures, network outages, or hardware malfunctions. By distributing resources across fault domains, cloud applications can minimize the impact of localized failures and increase overall availability.

One or more embodiments execute this process by leveraging the capabilities of the underlying cloud infrastructure to distribute the provisioned nodes strategically. To achieve distributed provisioning across availability domains, one or more embodiments interact with the cloud provider's APIs to specify the desired availability zones or regions for deploying the nodes. For instance, one or more embodiments may utilize, e.g., AWS Availability Zones or Google Cloud Regions to spread the provisioned nodes across physically separate data centers to mitigate the impact of localized failures. Similarly, for fault domain distribution, one or more embodiments employ cloud-specific mechanisms to distribute nodes across fault domains, which are logical or physical groupings of resources susceptible to shared failure scenarios. For example, one or more embodiments may use, e.g., Azure Fault Domains or Kubernetes taints and tolerations to ensure that provisioned nodes are placed in distinct failure domains to enhance fault isolation. One or more embodiments implement load-balancing strategies to distribute workload and traffic across the provisioned nodes deployed in multiple availability domains and fault domains. For example, one or more embodiments may configure a load balancer to evenly distribute incoming requests among nodes across different fault domains, thereby improving overall system performance and resilience. One or more embodiments may leverage cloud-native orchestration tools such as, e.g., Kubernetes or AWS Auto Scaling Groups to manage the lifecycle of provisioned nodes in a distributed manner. For example, one or more embodiments may utilize Kubernetes node affinity and anti-affinity rules to control how pods are scheduled onto nodes based on availability domain or fault domain considerations.

One or more embodiments may perform the additional steps of: determining whether distribution of one or both of: the first subset of the set of nodes, and the third subset of the second subset of the set of nodes in the cloud environment is suboptimal; performing a third evaluation of whether re-distributing the first subset of the set of nodes and the third subset of the second subset of the set of nodes in the cloud environment is possible; and re-distributing the first subset of the set of nodes and the third subset of the second subset of the set of nodes in the cloud environment. First, one or more embodiments assess whether the current placement of nodes from the provisioned subsets (first subset and third subset) across the cloud environment is suboptimal. This evaluation involves analyzing factors such as, e.g., network latency, resource utilization, and fault domain distribution. For example, one or more embodiments may identify instances where a large number of nodes are concentrated within a single availability domain or where critical resources are unevenly distributed. Upon determining suboptimal distribution, one or more embodiments proceed to perform a third evaluation to assess the feasibility of re-distributing the nodes. This evaluation considers various constraints and policies governing node placement, such as availability domain limits or network topology requirements. One or more embodiments may use algorithms to calculate the impact of potential re-distribution on system performance, ensuring that the proposed changes align with predefined goals and constraints. If deemed feasible, one or more embodiments initiate the re-distribution process to optimize the placement of nodes across the cloud environment. This involves migrating nodes between availability domains or fault domains to achieve a more balanced and efficient configuration. For example, nodes may be moved to different physical servers or network segments to reduce latency or enhance fault isolation. One or more embodiments employ orchestration mechanisms and automation tools to facilitate seamless node migration while minimizing disruption to running services. One embodiment could involve using machine learning algorithms to predict future workload patterns and optimize node placement accordingly. For example, nodes experiencing high utilization may be moved closer to data sources or processing units to reduce latency and improve response times. Another embodiment may leverage real-time monitoring and feedback loops to dynamically adjust node distribution based on observed performance metrics, ensuring continuous optimization in response to changing workload conditions.

One or more embodiments determine suboptimal distributions of nodes by analyzing the distribution of nodes across availability domains and fault domains to identify instances where more than a specified threshold of nodes are located within a single fault domain, and determining that all copies of a slot range for the cluster are within a single fault domain or availability domain. One or more embodiments may specifically target instances where more than a specified threshold of nodes are located within a single fault domain. This scenario poses a risk because a fault or outage in that domain could disproportionately impact a large portion of the provisioned nodes. By identifying such concentrations, one or more embodiments can prioritize redistributing nodes to achieve a more balanced distribution across fault domains and mitigate potential risks. Another aspect involves examining the distribution of slot ranges used by the cluster across fault domains or availability domains. A slot range typically refers to a specific portion of data or workload managed by the cluster. If all copies of a slot range are located within a single fault domain or availability domain, it indicates a potential single point of failure or performance bottleneck. One or more embodiments detect and flag such scenarios to guide redistribution efforts and enhance fault tolerance. Further, one or more embodiments may utilize statistical analysis to compute node distribution metrics across fault domains and availability domains, highlighting areas of imbalance or risk. For example, an algorithm could identify fault domains exceeding a predefined node concentration threshold and trigger automatic redistribution actions. Another embodiment may integrate historical data and predictive analytics to anticipate potential issues based on workload patterns and recommend proactive node reassignments to optimize performance and resilience.

One or more embodiments transmit, to one or more client devices, one or more status updates regarding status of cluster creation, the status updates comprising any deviations from the request to provision the cluster in the cloud environment. One or more embodiments may implement real-time updates, providing clients with immediate information about the ongoing deployment of their requested cluster. For example, notifications could be sent at key milestones, such as when the first subset of nodes is provisioned or when the cluster configuration begins to deviate from the initial request due to resource constraints. Additionally, one or more embodiments can generate alerts or notifications when unexpected issues arise during provisioning, such as node allocation failures or delays. These notifications may include details about the nature of the problem and any corrective actions being taken to resolve it. Another aspect involves one or more embodiments providing detailed logs or reports accessible via user interfaces or APIs, allowing clients to review the entire provisioning process retrospectively. Clients can, for example, monitor the status of their cluster creation, view historical updates, and understand how any deviations from the initial request were managed and resolved. One or more embodiments may support customizable notification preferences, enabling clients to specify the level of detail and frequency of updates they wish to receive. For example, clients may opt to receive comprehensive notifications for critical events but only periodic summaries for routine progress updates.

One or more embodiments implement one or more anti-entropy mechanisms to prevent data loss during node failures or domain disruptions. Various embodiments employ these anti-entropy mechanisms to maintain data consistency and integrity, particularly in distributed computing environments. One approach involves periodic reassignment of nodes to evenly distribute them across fault domains and availability domains. By redistributing nodes across different domains, one or more embodiments mitigate the impact of domain-specific failures on data availability and resilience. This proactive redistribution enhances fault tolerance and minimizes the risk of data loss due to domain-related issues. Another anti-entropy mechanism entails rebalancing shard node counts by creating additional nodes in different fault domains and availability domains. When certain domains experience heightened workload or potential disruptions, one or more embodiments dynamically adjust shard distribution by provisioning new nodes in alternative domains. This adaptive rebalancing optimizes data resilience and ensures continuous availability across the cluster. One or more embodiments may monitor node health and domain status in real-time to detect potential failures or disruptions. Upon identifying anomalies or deteriorations in domain performance, anti-entropy mechanisms can trigger proactive measures such as, e.g., data replication, node reassignment, or domain-specific load balancing to uphold data durability and availability.

### 4. Provisioning Nodes in a Distributed Fashion

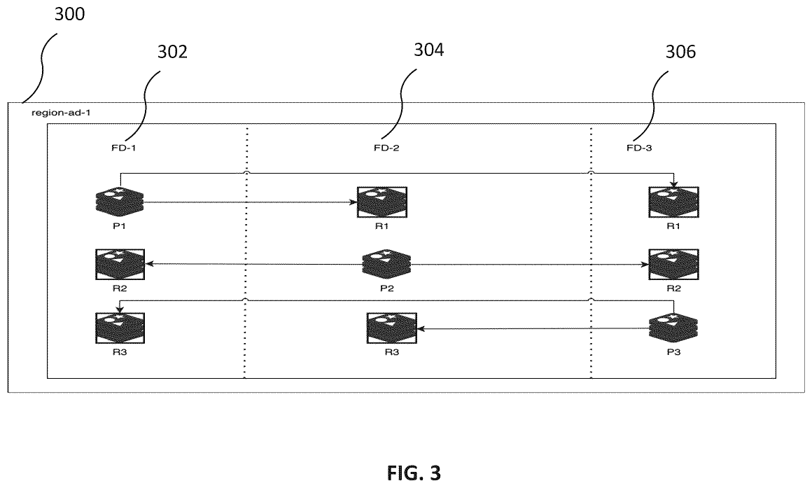

FIG. 3 illustrates an example embodiment where provisioning nodes is performed in a distributed fashion across availability domains and fault domains.

The figure illustrates one example of a target configuration of nodes distributed across fault domains and availability domains. A single availability domain 300 is depicted. Within the single availability domain, three fault domains—Fault Domain 1 302, Fault Domain 2 304, and Fault Domain 3 306 are depicted. Fault Domain 1 302 contains a Primary Node 1, Replica Node 2, and Replica Node 3. Fault Domain 2 304 contains a Replica Node 1, Primary Node 2, and Replica Node 3. Fault Domain 3 306 contains a Replica Node 1, Replica Node 2, and Primary Node 3. Primary Node 1 in Fault Domain 1 has replica nodes across Fault Domain 2 and Fault Domain 3; Primary Node 2 in Fault Domain 2 has replica nodes across Fault Domain 1 and Fault Domain 3; and Primary Node 3 in Fault Domain 3 has replica nodes across Fault Domain 1 and Fault Domain 2.

When the system creates instances for clusters, they are created within availability domains and fault domains. In some cases, the system determines that it does not have enough capacity to create instances. In such cases, when the system is not able to place a node in a particular availability domain and fault domain, the system instead places the node in a different availability domain and/or fault domain where there is enough availability, to work around capacity constraints. This is a tradeoff of fault tolerance for availability of clusters. Even if the illustrated “ideal” configuration cannot be met, the system will still let cluster creation pass, rather than fail, if it can create nodes across fault domains. One or more self-corrected processes, such as anti-entropy mechanisms, may thereafter be followed to allow the ideal configuration to reassert itself via the system over time to correct for the non-ideal state.

### 5. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

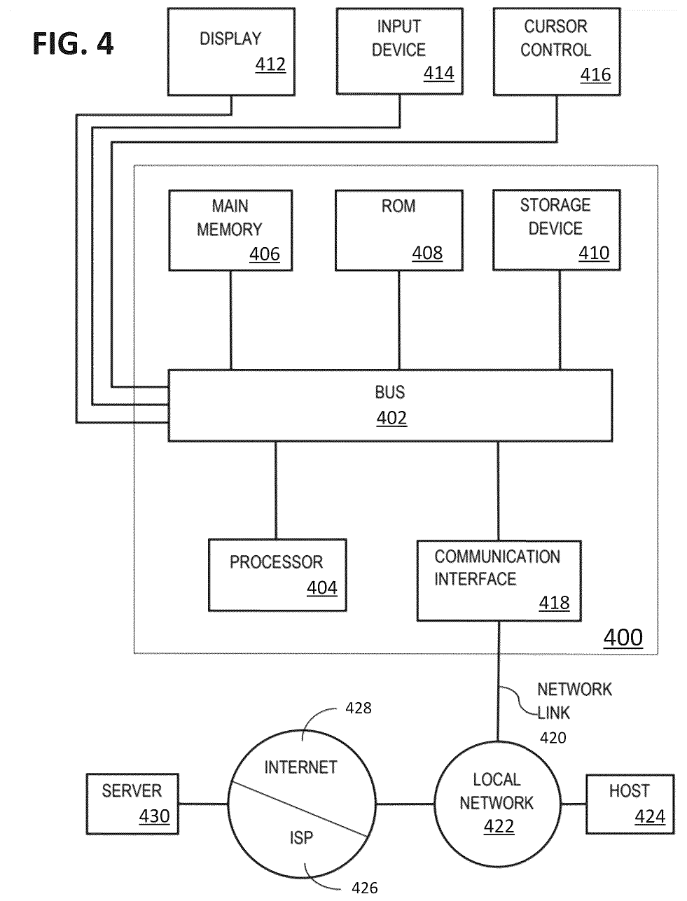

For example, FIG. 4 illustrates a computer system upon which some embodiments may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media storing instructions which, when executed by one or more hardware processors, cause performance of operations comprising:
receiving a request to provision a cluster in a cloud environment, wherein the cluster is to include a plurality of nodes, each node associated with a respective node configuration;
performing a first evaluation of whether provisioning each node of the plurality of nodes is possible;
based on the first evaluation, determining that provisioning a first subset of the plurality of nodes associated with respective node configurations is possible, and that provisioning a second subset of the plurality of nodes associated with respective node configurations is not possible;
provisioning the first subset of the plurality of nodes associated with respective node configurations for the cluster;
performing a second evaluation of whether provisioning each of the second subset of the plurality of nodes associated with respective node configurations is possible;
based on the second evaluation, determining that provisioning a third subset of the second subset of the plurality of nodes associated with respective node configurations is possible; and
further provisioning the third subset of the second subset of the plurality of nodes associated with respective node configurations for the cluster.

2. The one or more non-transitory computer-readable media of claim 1, wherein provisioning the first subset of the plurality of nodes and further provisioning the third subset of the second subset of the plurality of nodes are performed in a distributed fashion across availability domains and fault domains.

3. The one or more non-transitory computer-readable media of claim 1, the instructions causing the performance of operations to further comprise:
determining whether distribution of one or both of: the first subset of the plurality of nodes, and the third subset of the second subset of the plurality of nodes in the cloud environment is suboptimal;
performing a third evaluation of whether re-distributing the first subset of the plurality of nodes and the third subset of the second subset of the plurality of nodes in the cloud environment is possible; and
re-distributing the first subset of the plurality of nodes and the third subset of the second subset of the plurality of nodes in the cloud environment.

4. The one or more non-transitory computer-readable media of claim 3, wherein determining suboptimal distributions of nodes comprises one or both of: analyzing the distribution of nodes across availability domains and fault domains to identify instances where more than a specified threshold of nodes are located within a single fault domain; and determining that all copies of a slot range for the cluster are within a single fault domain or availability domain.

5. The one or more non-transitory computer-readable media of claim 1, the instructions causing the performance of operations to further comprise:
transmitting, to one or more client devices, one or more status updates regarding status of cluster creation, the status updates comprising any deviations from the request to provision the cluster in the cloud environment.

6. The one or more non-transitory computer-readable media of claim 5, wherein transmitting the one or more status updates regarding the status of cluster creation comprises:
providing one or more real-time updates to the customer regarding progress of cluster deployment, including any deviations from the request to provision the cluster in the cloud environment; and
providing, via a user interface or application programming interface, access to a log of cluster activities.

7. The one or more non-transitory computer-readable media of claim 1, further comprising:
deploying a plurality of instances, wherein the first subset of the plurality of nodes are provisioned on the plurality of instances.

8. A method comprising:
receiving a request to provision a cluster in a cloud environment, wherein the cluster is to include a plurality of nodes associated with respective node configurations;
performing a first evaluation of whether provisioning each of the plurality of nodes associated with respective node configurations is possible;
based on the first evaluation, determining that provisioning a first subset of the plurality of nodes associated with respective node configurations is possible, and that provisioning a second subset of the plurality of nodes associated with respective node configurations is not possible;
provisioning the first subset of the plurality of nodes associated with respective node configurations for the cluster;
performing a second evaluation of whether provisioning each of the second subset of the plurality of nodes associated with respective node configurations is possible;
based on the second evaluation, determining that provisioning a third subset of the second subset of the plurality of nodes associated with respective node configurations is possible; and
further provisioning the third subset of the second subset of the plurality of nodes associated with respective node configurations for the cluster.

9. The method of claim 8, wherein the request to provision the cluster further comprises a cluster configuration comprising one or more of: a number of shards, a number of nodes, and a specified memory allocation for the nodes.

10. The method of claim 8, further comprising:
implementing one or more anti-entropy mechanisms to prevent data loss during node failures or domain disruptions.

11. The method of claim 10, wherein the one or more anti-entropy mechanisms comprise one or both of: periodically reassigning one or more nodes to evenly distribute nodes across fault domains and availability domains; or rebalancing shard node counts by creating one or more nodes in a different fault domain and availability domain.

12. The method of claim 8, wherein node configuration comprises one or more of: a specified amount of memory allocation for each node, a desired number of shards to be included in the cluster, and a target number of nodes to be provisioned for the cluster.

13. The method of claim 8, wherein provisioning the first subset of the plurality of nodes and further provisioning the third subset of the second subset of the plurality of nodes are performed in a distributed fashion across availability domains and fault domains.

14. The method of claim 8, further comprising:
determining whether distribution of one or both of: the first subset of the plurality of nodes, and the third subset of the second subset of the plurality of nodes in the cloud environment is suboptimal;
performing a third evaluation of whether re-distributing the first subset of the plurality of nodes and the third subset of the second subset of the plurality of nodes in the cloud environment is possible; and
re-distributing the first subset of the plurality of nodes and the third subset of the second subset of the plurality of nodes in the cloud environment.

15. A system comprising:
one or more hardware processors;
one or more non-transitory computer-readable media; and
program instructions stored on the one or more non-transitory computer readable media which, when executed by the one or more hardware processors, cause the system to perform operations comprising:
receiving a request to provision a cluster in a cloud environment, wherein the cluster is to include a plurality of nodes associated with respective node configurations;
performing a first evaluation of whether provisioning each of the plurality of nodes associated with respective node configurations is possible;
based on the first evaluation, determining that provisioning a first subset of the plurality of nodes associated with respective node configurations is possible, and that provisioning a second subset of the plurality of nodes associated with respective node configurations is not possible;
provisioning the first subset of the plurality of nodes associated with respective node configurations for the cluster;
performing a second evaluation of whether provisioning each of the second subset of the plurality of nodes associated with respective node configurations is possible;
based on the second evaluation, determining that provisioning a third subset of the second subset of the plurality of nodes associated with respective node configurations is possible; and
further provisioning the third subset of the second subset of the plurality of nodes associated with respective node configurations for the cluster.

16. The system of claim 15, wherein provisioning the first subset of the plurality of nodes and further provisioning the third subset of the second subset of the plurality of nodes are performed in a distributed fashion across availability domains and fault domains.

17. The system of claim 15, wherein the program instructions further cause the system to perform operations comprising:
determining whether distribution of one or both of: the first subset of the plurality of nodes, and the third subset of the second subset of the plurality of nodes in the cloud environment is suboptimal;
performing a third evaluation of whether re-distributing the first subset of the plurality of nodes and the third subset of the second subset of the plurality of nodes in the cloud environment is possible; and
re-distributing the first subset of the plurality of nodes and the third subset of the second subset of the plurality of nodes in the cloud environment.

18. The system of claim 17, wherein determining suboptimal distributions of nodes comprises one or both of: analyzing the distribution of nodes across availability domains and fault domains to identify instances where more than a specified threshold of nodes are located within a single fault domain; and determining that all copies of a slot range for the cluster are within a single fault domain or availability domain.

19. The system of claim 15, wherein the program instructions further cause the system to perform an operation comprising:
transmitting, to one or more client devices, one or more status updates regarding status of cluster creation, the status updates comprising any deviations from the request to provision the cluster in the cloud environment.

20. The system of claim 15, wherein the program instructions further cause the system to perform an operation comprising:
deploying a plurality of instances, wherein the first subset of the plurality of nodes are provisioned on the plurality of instances.
